(19) United States
(12) Patent Application Publication
(10) Pub. No.: US 2010/0317561 A1
(43) Pub. Date: Dec. 16, 2010

(54) Low-Concentration Liquid Detergents or Cleaners Containing Perfume

(76) Inventors: Theodor Völkel, Erkrath (DE); Sören Hölsken, Duesseldorf (DE); Bernhard Guckenbiehl, Koln (DE)

Correspondence Address: Henkel Corporation, 10 Finderne Avenue, Suite B, Bridgewater, NJ, 08807, US

(21) Appl. No.: 12/861,430

(22) Filed: Aug. 23, 2010

Related U.S. Application Data
(63) Continuation of application No. PCT/EP2009/050419, filed on Jan. 15, 2009.

(30) Foreign Application Priority Data
Feb. 29, 2008 (DE) 102008012061.8

(51) Int. Cl. C11D 3/50

(52) U.S. Cl. 510/340

(57) ABSTRACT

Storage-stable liquid detergent or cleaner containing perfume oil and up to 25% by weight of a surfactant mixture of nonionic and anionic surfactants, where the ratio of nonionic surfactants to anionic surfactants is at least 0.75:1, and the ratio of nonionic surfactants to perfume oil is from 5:1 to 30:1. Use of the liquid detergent or liquid cleaner and to a process for its preparation is further provided. In addition, use of a surfactant mixture of nonionic and anionic surfactants for improving storage stability of a liquid detergent or cleaner containing perfume oil is described.

### CROSS REFERENCE TO RELATED APPLICATIONS

The present application is a continuation of International Patent Application No. PCT/EP2009/050419 filed 15 Jan. 2009, which claims the benefit of German Patent Application No. 10 2008 012 061.8 filed 29 Feb. 2008, both of which are incorporated herein by reference.

The present invention relates to a liquid washing or cleaning agent containing a surfactant mixture of anionic and nonionic surfactants and a perfume. The invention also relates to use of the washing or cleaning agent and to a method for the production thereof.

When attempting to produce less expensive liquid washing and cleaning agents with identical or even improved performance, the attempt is often made by reducing the quantity of surfactant and/or varying the nature of the surfactant.

It has, however, been found that it is difficult to incorporate relatively large quantities of perfume (i.e., quantities from 0.4 wt. % upwards) in liquid washing or cleaning agents having a low surfactant content (i.e., a surfactant content of at most 25 wt. %). For instance, problems arise with regard to storage stability, particularly on storage at low temperatures (i.e., temperatures of from 0 to 10° C.). Presumably, the small quantity of surfactant is no longer sufficient to create a stable dispersion in particular of the hydrophobic components of the perfume oil.

It is an object of the invention to provide a low-concentration, liquid washing or cleaning agent containing perfume oil which is stable in storage under the most varied climatic conditions and is not subject to phase separation.

This object is achieved by a liquid washing or cleaning agent containing a perfume oil and up to 25 wt. % of a surfactant mixture of nonionic and anionic surfactants, wherein the ratio of nonionic surfactants to anionic surfactants is at least 0.75:1 and the ratio of nonionic surfactants to perfume oil is from 5:1 to 30:1.

Advantageously, the ratio of nonionic surfactants to perfume oil is from 5:1 to 15:1, and more preferably from 5:1 to 10:1.

From an application standpoint, liquid washing and cleaning agents preferably contain a surfactant mixture of nonionic and anionic surfactants. Nonionic surfactants are particularly effective on greasy soiling. Anionic surfactants are used because of their good water solubility and their high washing power at low temperatures. It has now surprisingly been found that elevated contents of perfume oil may be incorporated into a storage stable, low-concentration, liquid washing or cleaning agent if the nonionic surfactants are present in an amount of at least 75% of the quantity by weight of anionic surfactants, thus at least in a ratio of 0.75:1. The resultant washing or cleaning agent is stable in storage under various climatic conditions, particularly at low storage temperatures.

Preferably the quantity of surfactant mixture in the agent is present in an amount of from 5 to 18 wt. %, preferably 8 to 15 wt. %, in each case relative to the total quantity of washing or cleaning agent.

It is advantageous on cost grounds and also from an environmental standpoint to keep the total quantity of surfactants as low as possible.

Preferably the ratio of nonionic surfactants to anionic surfactants is from 0.75:1 to 5:1, preferably from 0.75:1 to 3:1.

It has been found that ideal stabilization of the perfume oil combined with good washing performance is achieved at this ratio of nonionic surfactants to anionic surfactants.

It is advantageous for the anionic surfactant to be chosen from sulfonates, sulfates, soaps and mixtures thereof.

According to the invention, these anionic surfactants impart good cleaning performance on greasy soiling to a liquid washing or cleaning agent according to the invention containing a surfactant mixture of nonionic and anionic surfactants.

It is particularly preferred that the anionic surfactant be at least an alkylaryl sulfonate and the quantity of alkylaryl sulfonate present to amount to 3.2 wt. % or greater.

Alkylaryl sulfonates are preferred in washing or cleaning agents according to the invention due to their washing power. It has, however, been found that the washing or cleaning agent should preferably contain more than 3.2 wt. % of these anionic surfactants in order to achieve sufficiently good cleaning performance of the liquid washing or cleaning agent, particularly on greasy stains.

In one particularly preferred embodiment, the washing or cleaning agent contains 2 to 12 wt. %, and preferably 3 to 10 wt. % of a polyol, based on total quantity of washing or cleaning agent. The polyol can be chosen from glycerol, 1,2-propanediol, 1,3-propanediol, ethylene glycol, diethylene glycol, dipropylene glycol and mixtures thereof. In one very particularly preferred embodiment, the agent contains glycerol.

It has surprisingly been found that washing or cleaning agents containing specific quantities of polyol are more stable than washing or cleaning agents comprising other solvents not containing polyol. In addition to the increase in storage stability, particularly at low storage temperature, chemical stability of the ingredients, particularly enzymes, is also increased.

It is further preferred that the quantity of perfume oil present is from 0.4 to 1.5 wt. %, preferably 0.7 to 1.3 wt. %, based on total quantity of washing or cleaning agent.

Since many consumers purchase a washing or cleaning agent due to its scent, particularly the scent which it imparts to washed textiles, it is desirable to incorporate the greatest possible quantity of perfume oil into the low-concentration, liquid washing or cleaning agents. However, users deem excessively large quantities of perfume oil to be negative “over-perfuming”; accordingly, a range from 0.4 to 1.5 wt. %, particularly from 0.7 to 1.3 wt. %, based on total quantity of washing or cleaning agent, has proven to be an ideal range.

It is also preferred that the perfume oil contains at least 15 wt. % of fragrances with a boiling point of above 250° C. and a logP value of ≧3.0.

Such perfume oils may also be described as “hydrophobic perfume oils”, and on textiles exhibit a better scenting action with regard to attractiveness, intensity and durability of the scent impression.

The invention furthermore relates to use of the washing or cleaning agent according to the invention for washing and/or cleaning textile fabrics.

In a further aspect, the invention relates to a method for producing a liquid washing or cleaning agent containing a perfume oil and a surfactant mixture of nonionic and anionic surfactants, wherein nonionic surfactants are added to the agent in at least a ratio 0.75:1 relative to the anionic surfactants, and in a ratio of between 5:1 and 30:1 relative to the perfume oil.

The invention also relates to the use of a surfactant mixture of nonionic and anionic surfactants in a quantity of up to 25 wt. %, in which the ratio of nonionic surfactants to anionic surfactants amounts to at least 0.75:1, for improving the storage stability of a liquid washing or cleaning agent comprising a perfume oil and stored in specific temperature ranges, providing that the ratio of nonionic surfactants to perfume oil amounts to between 5:1 and 30:1. Stabilization is particularly effective on storage at a temperature range of from 0° C. to 10° C., on storage at a temperature range of from 10° C. to 25° C., and on storage at a temperature range of from 25° C. to 40° C.

By using the surfactant mixture according to the invention, it is possible to obtain liquid washing or cleaning agents with elevated perfume contents which are stable in storage under the most varied climatic conditions. In particular, storage stability of the liquid washing or cleaning agents is improved at a temperature range of from 0° C. to 10° C.

The invention will be described in greater detail below, inter alia with reference to the Examples.

The washing or cleaning agent contains up to 25 wt. % of a surfactant mixture of anionic and nonionic surfactants.

Alkoxylated, advantageously ethoxylated, particularly primary alcohols with preferably 8 to 18 C atoms and on average 1 to 12 mol of ethylene oxide (EO) per mol of alcohol, wherein the alcohol residue may be linear or preferably methyl-branched in position 2, or may contain linear and methyl-branched residues in the mixture as are usually present in oxo-alcohol residues, are preferably used as nonionic surfactants. In particular, however, alcohol ethoxylates with linear residues prepared from alcohols of natural origin with 12 to 18 C atoms, for example, from coconut, palm, tallow fat or oleyl alcohol, and on average 2 to 8 EO per mol of alcohol are preferred. Preferred ethoxylated alcohols include C₁₂₋₁₄ alcohols with 3 EO, 4 EO or 7 EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohols with 3 EO and C₁₂₋₁₈ alcohols with 7 EO. The stated degrees of ethoxylation are statistical averages which for a specific product may be an integer or a fractional number. Preferred alcohol ethoxylates have a narrow homologue distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO. Nonionic surfactants containing EO and PO groups together in one molecule may also be used according to the invention. In this respect it is possible to use block copolymers with EO-PO block units or PO-EO block units, or also EO-PO-EO copolymers or PO-EO-PO copolymers. Mixed alkoxylated nonionic surfactants may also be used, wherein EO and PO units are distributed randomly rather than in blocks. Such products are obtainable by simultaneous action of ethylene and propylene oxide on fatty alcohols.

A mixture of a branched ethoxylated fatty alcohol and an unbranched ethoxylated fatty alcohol, such as a mixture of a C₁₆₋₁₈ fatty alcohol with 7 EO and 2-propylheptanol with 7 EO, is furthermore also suitable.

Alkyl glucosides of the general formula RO(G)ₓ, wherein R is a primary straight-chain or methyl-branched aliphatic residue, particularly methyl-branched in position 2, with 8 to 22, preferably 12 to 18 C atoms, and G denotes a glycoside unit with 5 or 6 C atoms, preferably glucose, may moreover also be used as further nonionic surfactants. The degree of oligomerization x, which indicates the distribution of monoglycosides and oligoglycosides, is any desired number from 1 to 10; x is preferably 1.2 to 1.4. Alkyl glucosides are known, gentle surfactants.

A further class of preferably used nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain, in particular fatty acid methyl esters.

Nonionic surfactants of the amine oxide type, for example, N-coconut alkyl-N,N-dimethylamine oxide and N-tallow alcohol-N,N-dihydroxyethylamine oxide, and of the fatty acid alkanolamide type may also be suitable. Polyhydroxyfatty acid amides are further suitable surfactants.

From a performance standpoint and with regard to biodegradability, a linear ethoxylated alcohol with 8 to 18 C atoms and on average 1 to 12 mol of ethylene oxide (EO) per mol is particularly preferably used.

The content of nonionic surfactants in the washing or cleaning agent is preferably from 2 to 12.5 wt. %, more preferably 4 to 10 wt. %, and particularly 5 to 8 wt %, based on total washing or cleaning agent.

In addition to the nonionic surfactant(s), the surfactant mixture of the washing or cleaning agent must also contain an anionic surfactant. Sulfonates, sulfates, soaps and mixtures thereof are preferably used as the anionic surfactant.

Surfactants of the sulfonate type which may preferably be considered include C₉₋₁₃ alkylbenzene sulfonates, olefin sulfonates (i.e., mixtures of alkene and hydroxyalkane sulfonates) and disulfonates, as are obtained, for example, from C₁₂₋₁₈ monoolefins with a terminal or internal double bond by sulfonation with gaseous sulfur trioxide and subsequent alkaline or acidic hydrolysis of the sulfonation products. Alkane sulfonates obtained from C₁₂₋₁₈ alkanes, for example, by sulfochlorination or sulfoxidation with subsequent hydrolysis or neutralization are also suitable. Likewise, esters of α-sulfofatty acids (ester sulfonates) are also suitable, for example, the α-sulfonated methyl esters of hydrogenated coconut, palm kernel or tallow fatty acids.

Preferred alk(en)yl sulfates include the alkali metal, particularly sodium salts of sulfuric acid semi-esters of C₁₂-C₁₈ fatty alcohols (e.g., prepared from coconut fatty alcohol, tallow fatty alcohol, lauryl, myristyl, cetyl or stearyl alcohol), or C₁₀-C₂₀ oxo alcohols and semi-esters of secondary alcohols of these chain lengths. Alk(en)yl sulfates of the stated chain length having a synthetic straight-chain alkyl residue produced on a petrochemical basis and which exhibit degradation behavior similar to that of the appropriate compounds based on fatty chemical raw materials are also preferred. C₁₂-C₁₆ alkyl sulfates and C₁₂-C₁₅ alkyl sulfates and C₁₄-C₁₅ alkyl sulfates are preferred because of their washing characteristics. 2,3-Alkyl sulfates, commercially available products from Shell Oil Company under the tradename DAN®, are suitable anionic surfactants.

Sulfuric acid monoesters of straight-chain or branched C₇₋₂₁ alcohols ethoxylated with 1 to 6 mol of ethylene oxide are also suitable, such as 2-methyl-branched C₉₋₁₁ alcohols with on average 3.5 mol of ethylene oxide (EO) or C₁₂₋₁₈ fatty alcohols with 1 to 4 EO.

Further suitable anionic surfactants include the salts of alkylsulfosuccinic acid, also known as sulfosuccinates or sulfosuccinic acid esters, and are the monoesters and/or diesters of sulfosuccinic acid with alcohols, preferably fatty alcohols, and particularly ethoxylated fatty alcohols. Preferred sulfosuccinates contain C₈₋₁₈ fatty alcohol residues or mixtures thereof. Particularly preferred sulfosuccinates contain a fatty alcohol residue derived from ethoxylated fatty alcohols, which are nonionic surfactants. Sulfosuccinates whose fatty alcohol residues are derived from ethoxylated fatty alcohols with a narrow homolog distribution are particularly preferred. It is likewise also possible to use alk(en)yl succinic acid with preferably 8 to 18 carbon atoms in the alk(en)yl chain or the salts thereof.

Soaps are also preferred anionic surfactants. Saturated and unsaturated fatty acid soaps are particularly suitable, such as the salts of lauric acid, myristic acid, palmitic acid, stearic acid, (hydrogenated) erucic acid and behenic acid, and in particular soap mixtures derived from natural fatty acids (e.g., coconut, palm kernel, olive oil or tallow fatty acids).

Anionic surfactants including soaps may be present in the form of their sodium, potassium or magnesium salts. The anionic surfactants are preferably present in the form of the sodium salts thereof. A further preferred counterion for anionic surfactants is choline.

Preferably the surfactant mixture contains a sulfonate surfactant as anionic surfactant. It is still more preferred, however, if the sulfonate surfactants present in the surfactant mixture are blended with a soap. Sulfonate surfactants preferably usable in the invention include alkylaryl sulfonates, preferably alkylbenzene sulfonates, and particularly preferably C₉₋₁₃ alkylbenzene sulfonates.

In order to ensure good washing performance on many kinds of stains, it is particularly preferred that the washing or cleaning agent according to the invention contains 3.2 wt. % or more of alkylbenzene sulfonates, relative to the total agent.

A washing or cleaning agent's content of anionic surfactants may amount to up to 14 wt. %, relative to the total washing or cleaning agent. A washing or cleaning agent's content of anionic surfactants is, preferably, however 10 wt. % or less, relative to the total agent.

In addition to the surfactant mixture, the washing or cleaning agent contains perfume oil. The perfume oil is preferably present in a quantity of 0.4 to 1.5 wt. %, more preferably 0.7 to 1.3 wt. %.

The ratio of perfume oil to nonionic surfactants is from 1:5 to 1:30, preferably 1:5 to 1:15, and more preferably from 1:5 to 1:10.

A person skilled in the relevant art of washing or cleaning agents is capable, in the stated ranges for the ratio of nonionic surfactants to anionic surfactants, the ratio of nonionic surfactants to perfume oil and the total surfactant content, to identify combinations according to the invention or to combine the individual ingredients (nonionic surfactant, anionic surfactant and perfume oil) according to the invention in order to arrive at the subject matter of the invention, namely low-concentration washing or cleaning agents with a relatively high perfume content which are stable under the most varied storage conditions. The term “relatively” does not relate in this connection to the absolute quantity of perfume which is present in the total washing or cleaning agent, but instead to the quantity of perfume which is present (in relative terms) in relation to the total quantity of surfactant.

Examples of useful perfume oils include individual fragrance compounds, for example synthetic products of the ester, ether, aldehyde, ketone, alcohol and hydrocarbon type. Preferably, however, mixtures of various fragrances are used which together produce an attractive scent note. Such perfume oils may also contain natural fragrance mixtures as are obtainable from plant sources.

In a preferred embodiment, the perfume oil contains at least 15 wt. % of fragrances with a boiling point of above 250° C. and a logP value of >3.0. It has been found that low-concentration washing or cleaning agents according to the invention containing perfume oils with such a minimum quantity of fragrances with a boiling point of above 250° C. and a logP value of ≧3.0 exhibit particularly advantageous scent properties. For example, a longer lasting scent impression on the laundry may be achieved. The absorption behavior of the fragrances in the dryer onto the laundry may likewise be still further improved such that the laundry is more intensely fragrant for a longer time.

The octanol/water distribution coefficient of a scent component is the ratio between its equilibrium concentration in octanol and in water. Since distribution coefficients of the scent components often have elevated values (e.g., 1000 or higher), they are conveniently stated in the form of their base 10 logarithm, known as the logP value. Preferred fragrances of the present invention exhibit a logP of 3.0 or higher, for example, ≧3.1, preferably ≧3.2, particularly ≧3.3.

The logP value of numerous fragrances is documented—for example, the Pomona92 database (available from Daylight Chemical Information Systems, Inc., (Daylight CIS), Irvine, Calif.) contains numerous logP values, together with original literature citations. However, logP values are most conveniently calculated using “CLOGP” software, also available from Daylight CIS. This software also lists the experimental logP-values, if they are available in the Pomona92 database. The “calculated logP” (ClogP value) is determined by fragment approximation according to Harsch and Leo (see A. Leo, in Comprehensive Medicinal Chemistry, Vol. 4, C. Harsch, P. G. Sammens, J. B. Taylor and C. A. Ransden, Eds., p. 295, Pergamon Press (1990), included herein by reference). Fragment approximation is based on the chemical structure of each of the scent components and takes account of the numbers and types of atoms, atomic binding power and chemical bonding. ClogP values, which are the most reliable and most widely used estimated values for this physicochemical property, are preferably used instead of experimental logP values for the purposes of selecting scent components used in the present invention.

Boiling points of numerous fragrances are stated, for example, in “Perfume and Flavor Chemicals (Aroma Chemicals)”, S. Arctander (1969), published by the author.

Other boiling point values may be obtained, for example, from various known handbooks of chemistry and databases. If a boiling point is only stated at a different pressure, generally at a pressure lower than standard pressure of 760 mm Hg, the boiling point at standard pressure may be roughly estimated with the assistance of boiling point/pressure nomographs, such as those given in “The Chemist's Companion”, A. J. Gordon and R. A. Ford, John Wiley & Sons. Publishers (1972), pp. 30-36. Where applicable, boiling point values may also be calculated by computer software on the basis of molecular structure data, such as described in “Computer-assisted Prediction of Normal Boiling Points of Pyrans and Pynoles”, D. T. Starton et al., J. Chem. Inf. Comput. Sci., 32 (1992), pp. 306-316, “Computer-assisted Prediction of Normal Boiling Points of Furans, Tetrahydrofurans and Thiophenes”, D. T. Starton et al., J. Chem. Inf. Comput. Sci., 31 (1992), pp. 301-310, and the references cited therein, and “Predicting Physical Properties from Molecular Structure”, R. Murugan et al., Chemtech. (June 1994), pp. 17-23.

Table 1 below lists some examples of fragrances which satisfy the criteria boiling point>250° C. and ClogP>3.

TABLE 1
Examples of fragrances

| Scent components with a boiling point | Approximate | |
|---|---|---|
| >250° C. and a ClogP ≧3.0 | boiling point (° C.) | ClogP |
| Allylcyclohexane propionate | 267 | 3.935 |
| Ambrettolide | 300 | 6.261 |
| Amyl benzoate | 262 | 3.417 |
| Amyl cinnamate | 310 | 3.771 |
| Amylcinnamaldehyde | 285 | 4.324 |
| Amylcinnamaldehyde dimethyl acetal | 300 | 4.033 |
| Isoamyl salicylate | 277 | 4.601 |
| Aurantiol | 450 | 4.216 |
| Benzophenone | 306 | 3.120 |
| Benzyl salicylate | 300 | 4.383 |
| Para-tert.-butylcyclohexyl acetate | >250 | 4.019 |
| Isobutyl quinoline | 252 | 4.193 |
| Beta-caryophyllene | 256 | 6.333 |
| Cardinene | 275 | 7.346 |
| Cedrol | 291 | 4.530 |
| Cedryl acetate | 303 | 5.436 |
| Cedryl formate | >250 | 5.070 |
| Cinnamyl cinnamate | 370 | 5.480 |
| Cyclohexyl salicylate | 304 | 5.265 |
| Cyclamen aldehyde | 270 | 3.680 |
| Dihydroisojasmonate | >300 | 3.009 |
| Diphenylmethane | 262 | 4.059 |
| Diphenyl oxide | 252 | 4.240 |
| Dodecane lactone | 258 | 4.359 |
| Iso E Super | >250 | 3.455 |
| Ethyl brassylate | 321 | 4.554 |
| Ethylmethylphenyl glycinate | 260 | 3.165 |
| Ethyl undecylenate | 264 | 4.888 |
| Exaltolide | 280 | 5.346 |
| Galaxolide | >250 | 5.482 |
| Geranyl anthranilate | 312 | 4.216 |
| Geranyl phenylacetate | >250 | 5.233 |
| Hexadecanolide | 294 | 6.805 |
| Hexenyl salicylate | 271 | 4.716 |
| Hexylcinnamaldehyde | 305 | 5.473 |
| Hexyl salicylate | 290 | 5.260 |
| Alpha-irone | 250 | 3.820 |
| Lilial (p-t-bucinal) | 258 | 3.858 |
| Linalyl benzoate | 263 | 5.233 |
| 2-Methoxynaphthalene | 274 | 3.235 |
| Methyl dihydrojasmone | >300 | 4.843 |
| Gamma-n-methylionone | 252 | 4.309 |
| Musk indanone | >250 | 5.458 |
| Musk ketone | mp = 137° C. | 3.014 |
| Musk tibetine | mp = 136° C. | 3.831 |
| Myristicin | 276 | 3.200 |
| 10-Oxahexadecanolide | >300 | 4.336 |
| 11-Oxahexadecanolide | mp = 35° C. | 4.336 |
| Patchouli alcohol | 285 | 4.530 |
| Phantolide | 288 | 5.977 |
| Phenylethyl benzoate | 300 | 4.058 |
| Phenylethyl phenyl acetate | 325 | 3.767 |
| Phenylheptanol | 261 | 3.478 |
| Phenylhexanol | 258 | 3.299 |
| Alpha-santalol | 301 | 3.800 |
| Thibetolide | 280 | 6.246 |
| Delta-undecalactone | 290 | 3.830 |
| Gamma-undecalactone | 297 | 4.140 |
| Vetiveryl acetate | 285 | 4.882 |
| Yara-yara | 274 | 3.235 |

“mp” is the melting point; these components have a boiling point higher than 250° C.

Table 1 provides a sufficient number of non-limiting examples of fragrances which are preferably usable for the purposes of the present invention. Perfume oils of washing or cleaning agents according to the invention preferably contain at least 3 different fragrances, more preferably at least 4 different fragrances, and still more preferably at least 5 different fragrances.

In addition to the surfactants and the perfume oil, the washing or cleaning agents may contain further ingredients which further enhance the application and/or esthetic characteristics of the washing or cleaning agent. For the purposes of the present invention, the washing or cleaning agent preferably additionally contains one or more substances chosen from builders, bleaching agents, bleach catalysts, bleach activators, enzymes, electrolytes, nonaqueous solvents, pH adjusting agents, perfume carriers, fluorescent agents, dyes, hydrotropes, foam inhibitors, silicone oils, antiredeposition agents, graying inhibitors, shrinkage prevention agents, anticrease agents, dye transfer inhibitors, antimicrobial active substances, germicides, fungicides, antioxidants, preservatives, corrosion inhibitors, antistatic agents, bitter agents, ironing aids, waterproofing and impregnation agents, anti-swelling and anti-slip agents, softening components and UV absorbers.

Examples of builders which may be present in the washing or cleaning agent include silicates, aluminum silicates (in particular zeolites), phosphates and carbonates.

For esthetic reasons, however, preferably soluble, organic builders are used in the liquid washing or cleaning agents.

Organic builders which may be present in the washing or cleaning agent include polycarboxylic acids, usable in the form of their sodium salts, polycarboxylic acids referring to those carboxylic acids which bear more than one acid function. These are, for example, citric acid, adipic acid, succinic acid, glutaric acid, malic acid, tartaric acid, maleic acid, fumaric acid, saccharic acids, aminocarboxylic acids, nitrilotriacetic acid (NTA), methylglycinediacetic acid (MGDA) and the derivatives thereof and mixtures of these. Preferred salts are the salts of polycarboxylic acids such as citric acid, adipic acid, succinic acid, glutaric acid, tartaric acid, saccharic acids and mixtures of these.

The acids themselves may also be used. Apart from their builder action, the acids typically also have the property of an acidifying component and so also serve to establish a lower and gentler pH value of washing or cleaning agents. Citric acid, succinic acid, glutaric acid, adipic acid, gluconic acid and any desired mixtures of these may in particular be mentioned.

Polymeric polycarboxylates are furthermore suitable as builders. These include the alkali metal salts of polyacrylic acid or of polymethacrylic acid.

Also suitable are copolymeric polycarboxylates, particularly those of acrylic acid with methacrylic acid and acrylic acid or methacrylic acid with maleic acid. Copolymers of acrylic acid with maleic acid containing 50 to 90 wt. % acrylic acid and 50 to 10 wt. % maleic acid have proven particularly suitable.

In particular, biodegradable polymers prepared from more than two different monomer units are preferred, for example, those containing salts of acrylic acid and of maleic acid and vinyl alcohol or vinyl alcohol derivatives as monomers or which contain salts of acrylic acid and of 2-alkylallylsulfonic acid and sugar derivatives as monomers.

Citric acid or the salts thereof is preferably used as soluble, organic builders in the liquid washing or cleaning agents.

The liquid washing or cleaning agent may also contain an enzyme or a mixture of enzymes. Suitable enzymes in particular those from the classes of hydrolases such as der proteases, (poly)esterases, lipases or lipolytically active enzymes, amylases, cellulases or other glycosylhydrolases, hemicellulase, cutinases, β-glucanases, oxidases, peroxidases, mannanases, perhydrolases, oxyreductases and/or laccases. Proteases, amylases, lipases, cellulases, mannanases, laccases, tannanases and esterases/polyesterases and mixtures of two or more of these enzymes are preferably used for the purposes of the present invention.

Relative to the total agent, the quantity of enzyme or enzymes amounts to 0.01 to 10 wt. %, preferably to 0.12 to approx. 3 wt. %. The enzymes are preferably used as liquid enzyme formulation(s).

Washing or cleaning agents according to the invention may contain stabilizers such as boric acid or borate, boric acid-derivatives or aminoalcohols to stabilize the enzymes.

A wide range of the most varied salts from the group of inorganic salts may be used as electrolytes. Preferred cations include alkali metals and alkaline earth metals; preferred anions include halides and sulfates. The proportion of electrolytes in the washing or cleaning agent conventionally amounts to 0.1 to 5 wt. %.

Nonaqueous solvents which may be used in the washing or cleaning agents originate, for example, from the group of mono- or polyhydric alcohols, alkanolamines or glycol ethers, provided that they are water-miscible in the stated concentration range. Solvents which may be used include ethanol, n- or i-propanol, butanols, glycol, propane- or butanediol, glycerol, diethylene glycol, diethylene glycol propyl or butyl ether, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy-, ethoxy- or butoxytriglycol, 1-butoxyethoxy-2-propanol, 3-methyl-3-methoxybutanol, propylene glycol t-butyl ether, di-n-octyl ether and mixtures of these solvents. Nonaqueous solvents may be used in the washing or cleaning agents in quantities of from 0.5 to 25 wt. %, preferably 20 wt. % or less, and particularly 15 wt. % or less.

Preferably the washing or cleaning agents contain specific quantities of a polyol as nonaqueous solvent. It is preferred for the washing or cleaning agent to contain 2 to 10 wt. % of a polyol. Suitable polyols include glycerol, 1,2-propanediol, 1,3-propanediol, ethylene glycol, diethylene glycol and/or dipropylene glycol. The washing or cleaning agent particularly preferably contains glycerol.

To bring the pH value of the washing or cleaning agent into the desired range, pH adjusting agents may be used. In this case, any known acids or alkalies may be used, provided that their use is not prohibited for application or environmental reasons or for reasons of consumer protection. The pH value of the washing or cleaning agent is preferably from 4 to 10, preferably from 6.5 to 9, and most preferably from 7 to 8.8.

The liquid washing or cleaning agents preferably have viscosities in the range from 200 to 5000 mPa·s, with values of from 300 to 2000 mPa·s, particularly 400 to 1000 mPa·s being particularly preferred. Viscosity is determined using a Brookfield LVT-II viscometer at 20 rpm and 20° C., spindle 3.

The esthetic impression of the washing or cleaning agent may be improved by dyeing it with suitable dyes. Preferred dyes, the selection of which will cause a person skilled in the art no difficulty, have elevated storage stability and are insensitive to the other ingredients of the washing or cleaning agents and to light and have no marked substantivity relative to textile fibers, so as not to dye the latter.

Foam inhibitors which may be considered for use in the washing or cleaning agents include soaps, paraffins or silicone compounds, particularly silicone oils, which may optionally assume emulsion form.

Suitable soil release polymers, also known as “antiredeposition agents”, include nonionic cellulose ethers such as methylcellulose and methylhydroxypropylcellulose and polymers from the prior art of phthalic acid and/or terephthalic acid or the derivatives thereof, particularly polymers prepared from ethylene terephthalates and/or polyethylene and/or polypropylene glycol terephthalates or anionically and/or nonionically modified derivatives of these. Suitable derivatives include sulfonated derivatives of polymers of phthalic acid and terephthalic acid.

Optical brighteners may be added to the washing or cleaning agents in order to eliminate graying and yellowing of the treated textile fabric. Suitable compounds are obtained for example from the substance classes comprising 4,4′-diamino-2,2′-stilbene disulfonic acids (flavone acids), 4,4′-distyryl biphenylene, methylumbelliferones, coumarins, dihydroquinolinones, 1,3-diaryl pyrazolines, naphthalic acid imides, benzoxazole, benzisoxazole and benzimidazole systems and pyrene derivatives substituted by heterocycles. The optical brighteners are conventionally used in quantities of from 0 to 0.3 wt. %, relative to the finished washing or cleaning agent.

Graying inhibitors have the task of keeping soiling which has been dissolved off the fibers in suspension in the liquor, so preventing redeposition of the soiling. Cellulose ethers such as carboxymethylcellulose (Na salt), methylcellulose, hydroxyalkylcellulose, mixed ethers (e.g., methylhydroxyethylcellulose, methylhydroxypropylcellulose and methylcarboxymethylcellulose) and mixtures thereof, are preferably used for this purpose, in quantities of 0.1 to 5 wt. %, based on total weight of washing or cleaning agent.

The washing or cleaning agent may contain a dye transfer inhibitor in order to ensure effective suppression of dye release and/or dye transfer onto other textiles during washing and/or cleaning of dyed textiles. Preferably the dye transfer inhibitor is a polymer or copolymer of cyclic amines such as vinylpyrrolidone and/or vinylimidazole. Polymers suitable as dye transfer inhibitors include polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride and mixtures thereof. Polyvinylpyrrolidone (PVP), polyvinylimidazole (PVI) or copolymers of vinylpyrrolidone and vinylimidazole (PVP/PVI) are particularly preferably used as a dye transfer inhibitor. Polyvinylpyrrolidones (PVP) are commercially available from ISP Chemicals as PVP K 15, PVP K 30, PVP K 60 or PVP K 90 or from BASF as Sokalan® HP 50 or Sokalan® HP 53. PVP/PVI copolymers are commercially available from BASF under the name Sokalan® HP 56.

The amount of dye transfer inhibitor relative to the total amount of washing or cleaning agent is preferably from 0.01 to 2 wt. %, preferably from 0.05 to 1 wt. % and more preferably from 0.1 to 0.5 wt. %.

Alternatively, however, enzymatic systems comprising a peroxidase and hydrogen peroxide or a substance which liberates hydrogen peroxide in water may also be used as a dye transfer inhibitor. The addition of a mediator compound for the peroxidase, for example of an acetosyringone, of a phenol derivative or of a phenothiazine or phenoxazine, is in this case preferred, it additionally being possible also to use the above-stated polymeric dye transfer inhibitors.

Washing or cleaning agents according to the invention may contain preservatives, preferably those which have no or only slight skin-sensitizing potential. Examples are sorbic acid and the salts thereof, benzoic acid and the salts thereof, salicylic acid and the salts thereof, phenoxyethanol, formic acid and the salts thereof, 3-iodo-2-propynyl butylcarbamate, sodium N-(hydroxymethyl)glycinate, biphenyl-2-ol and mixtures thereof. Further suitable preservatives are isothiazolones, mixtures of isothiazolones and mixtures of isothiazolones with other compounds, for example tetramethylolglycoluril.

To prevent decomposition catalyzed by heavy metals of certain washing agent ingredients, substances may be used which complex heavy metals. Suitable heavy metal complexing agents include the alkali metal salts of ethylenediaminetetraacetic acid (EDTA) or nitrilotriacetic acid (NTA), methylglycinediacetic acid (MGDA) and alkali metal salts of anionic polyelectrolytes such as polymaleates and polysulfonates.

A preferred class of complexing agents comprises phosphonates, present in the washing or cleaning agents in quantities of from 0.01 to 2.5 wt. %, preferably 0.02 to 2 wt. %, and particularly 0.03 to 1.5 wt. %. These preferred compounds include organophosphonates such as 1-hydroxyethane-1,1-diphosphonic acid (HEDP), aminotri(methylenephosphonic acid) (ATMP), diethylenetriaminepenta(methylenephosphonic acid) (DTPMP or DETPMP) and 2-phosphonobutane-1,2,4-tricarboxylic acid (PBS-AM), which are generally used in the form of their ammonium or alkali metal salts. Alternative complexing agents which may be used in the washing or cleaning agents include iminodisuccinates (IDS) or ethylenediamine-N,N′-disuccinate (EDDS).

Washing or cleaning agents according to the invention may be used for washing and/or cleaning textile fabrics.

The washing or cleaning agent is produced using conventional and known methods and processes. Components of the washing or cleaning agents may, for example, simply be mixed in stirred-tank reactors, with water, the acidic components, where present in each case, such as the alkylaryl sulfonates, citric acid, boric acid, phosphonic acid, the fatty alcohol ether sulfates, etc., and the nonionic surfactants conveniently being initially introduced. Nonaqueous solvents, when present, are preferably also added at this time, but may however also be added at a later point in the process. If present, the fatty acid is then added and the fatty acid fraction is saponified at 50 to 60° C. Further components are then added, preferably in portions. It is, however, vital for the added quantity of nonionic surfactant active substance to be at least equal to the added quantity of anionic surfactant active substance and for the quantity of perfume oil added to be from 0.5 to 1.5 wt. %, relative to the total quantity of washing or cleaning agent.

Table 2 below shows the compositions of two comparative formulations, V1 and V2, and the compositions of four washing or cleaning agents according to the invention, E1-E4 (all quantities are stated in wt. % active substance, relative to the agent):

TABLE 2
Composition of washing or cleaning agents V1 and V2 and E1 to E4 (stated in wt. %)

| | V1 | V2 | E1 | E2 | E3 | E4 |
|---|---|---|---|---|---|---|
| C₁₂₋₁₈ fatty alcohol with 7 EO | 5.2 | 5.5 | 6.4 | 6.4 | 6.8 | 7.2 |
| Linear C₁₀-C₁₃ alkylbenzene sulfonate | 6.85 | 6.42 | 6.42 | 5.35 | 4.82 | 4.28 |
| (Na salt) | | | | | | |
| C₁₂₋₁₈ fatty acid (sodium salt) | 1.98 | 1.98 | 1.98 | 1.98 | 1.98 | 1.98 |
| Citric acid (sodium salt) | 1 | 1 | 1 | 1 | 1 | 1 |
| Phosphonic acid | 0.5 | 0.5 | 0.5 | 0.5 | 0.5 | 0.5 |
| Boric acid (Na salt) | 1 | 1 | 1 | 1 | 1 | 1 |
| Polyacrylate thickener | 0.3 | 0.3 | 0.3 | 0.3 | 0.3 | 0.3 |
| Optical brightener | 0.08 | 0.08 | 0.08 | 0.08 | 0.08 | 0.08 |
| Glycerol | 3 | 3 | 3 | 3 | 3 | 3 |
| Ethanol | 1 | 1 | 1 | 1 | 1 | 1 |
| Silicone defoamer | 0.01 | 0.01 | 0.01 | 0.01 | 0.01 | 0.01 |
| Enzymes (protease & amylase) | 0.6 | 0.6 | 0.6 | 0.6 | 0.6 | 0.6 |
| Perfume A | 1.0 | 1.0 | 1.0 | 1.0 | 1.0 | 1.0 |
| Dye, preservative | + | + | + | + | + | + |
| Water | Ad 100 | Ad 100 | Ad 100 | Ad 100 | Ad 100 | Ad 100 |
| Nonionic surfactant to anionic | 0.58:1 | 0.65:1 | 0.76:1 | 0.87:1 | 1:1 | 1.15:1 |
| surfactant ratio | | | | | | |

The resultant washing or cleaning agents, V1-V2 and E1-E4, were subjected to storage tests simulating various climatic conditions.

TABLE 3
Visual evaluation of washing or cleaning agents, V1-V2 and E1-E4 after storage
under various climatic conditions

| | Week | V1 | V2 | E1 | E2 | E3 | E4 |
|---|---|---|---|---|---|---|---|
| 24° C. to 40° C. | 2 | OK | OK | OK | OK | OK | OK |
| | 4 | OK | OK | OK | OK | OK | OK |
| | 8 | OK | OK | OK | OK | OK | OK |
| 24° C. to 40° C. | 2 | OK | OK | OK | OK | OK | OK |
| Evaluation: RT | 4 | OK | OK | OK | OK | OK | OK |
| | 8 | OK | OK | OK | OK | OK | OK |
| 10° C. to 30° C. | 2 | OK | OK | OK | OK | OK | OK |
| | 4 | OK | OK | OK | OK | OK | OK |
| | 8 | OK | OK | OK | OK | OK | OK |
| 10° C. to 30° C. | 2 | OK | OK | OK | OK | OK | OK |
| Evaluation: RT | 4 | OK | OK | OK | OK | OK | OK |
| | 8 | OK | OK | OK | OK | OK | OK |
| 0° C. to 10° C. | 2 | UNSTABLE | UNSTABLE | OK | OK | OK | OK |
| | 4 | UNSTABLE | UNSTABLE | OK | OK | OK | OK |
| | 8 | UNSTABLE | UNSTABLE | OK | OK | OK | OK |
| 0° C. to 10° C. | 2 | UNSTABLE | UNSTABLE | OK | OK | OK | OK |
| Evaluation: RT | 4 | UNSTABLE | UNSTABLE | OK | OK | OK | OK |
| | 8 | UNSTABLE | UNSTABLE | OK | OK | OK | OK |

OK: no change
ACCEPTABLE: agent exhibits slight nonuniformities but is acceptable
UNSTABLE: agent is not acceptable (severe turbidity, creaming or phase separation)
RT: room temperature; corresponds to 20° C.

Washing or cleaning agents according to the invention were stored at the stated temperatures, the temperatures in each case fluctuating in a defined cycle within the stated temperature range. The evaluation was made either at room temperature or at the lowest temperature of a temperature range.

It is clear from the stability tests that establishing the ratio according to the invention of nonionic surfactants to anionic surfactants of at least 0.75:1 gives rise to low-concentration (the total surfactant content is from 13.87 wt. % in Example E1 and 13.46 wt. % in Example E4) washing or cleaning agents which are stable under the most varied climatic conditions. It is additionally clear that the washing or cleaning agents according to the invention are capable of dispersing the perfume oil in a storage-stable and homogenous manner at a lower total surfactant content.

Table 4 below shows the compositions of two comparative formulations, V3 and V4, and two formulations according to the invention, E5 and E6 (all quantities are stated in wt. % active substance, relative to the agent):

TABLE 4
Composition of washing or cleaning agents
V3 and V4 and E5 and E6 (stated in wt. %)

| | V3 | V4 | E5 | E6 |
|---|---|---|---|---|
| C₁₂₋₁₈ fatty alcohol with 7 EO | 5.2 | 5.2 | 6.4 | 6.4 |
| Linear C₁₀-C₁₃ alkylbenzene | 6.85 | 6.85 | 5.35 | 5.35 |
| sulfonate (Na salt) | | | | |
| C₁₂₋₁₈ fatty acid (sodium salt) | 1.98 | 1.98 | 1.98 | 1.98 |
| Citric acid (sodium salt) | 1.2 | 1.2 | 1.2 | 1.2 |
| Phosphonic acid | 0.5 | 0.5 | 0.5 | 0.5 |
| Boric acid (Na salt) | 1.06 | 1.06 | 1.06 | 1.06 |
| Polyacrylate thickener | 0.3 | 0.3 | 0.3 | 0.3 |
| Optical brightener | 0.08 | 0.08 | 0.08 | 0.08 |
| Glycerol | 3 | 3 | 3 | 3 |
| Ethanol | 1 | 1 | 1 | 1 |
| Silicone defoamer | 0.01 | 0.01 | 0.01 | 0.01 |
| Enzymes (protease & amylase) | 0.1 | 0.1 | 0.1 | 0.1 |
| Perfume B | 0.8 | 1.0 | 0.8 | 1.0 |
| Dye, preservative | + | + | + | + |
| Water | Ad 100 | Ad 100 | Ad 100 | Ad 100 |
| Nonionic surfactant to anionic | 0.59:1 | 0.59:1 | 0.87:1 | 0.87:1 |
| surfactant ratio | | | | |

TABLE 5
Visual evaluation of washing or cleaning agents V3 and V4 and E5
and E6 after storage under various climatic conditions

| | Week | V3 | V4 | E5 | E6 |
|---|---|---|---|---|---|
| 24° C. to 40° C. | 2 | OK | OK | OK | OK |
| | 4 | OK | OK | OK | OK |
| | 8 | OK | OK | OK | OK |
| 24° C. to 40° C. | 2 | OK | OK | OK | OK |
| Evaluation: RT | 4 | OK | OK | OK | OK |
| | 8 | OK | OK | OK | OK |
| 10° C. to 30° C. | 2 | OK | OK | OK | OK |
| | 4 | OK | OK | OK | OK |
| | 8 | OK | OK | OK | OK |
| 10° C. to 30° C. | 2 | OK | OK | OK | OK |
| Evaluation: RT | 4 | OK | OK | OK | OK |
| | 8 | OK | OK | OK | OK |
| 0° C. to 10° C. | 2 | UNSTABLE | UNSTABLE | OK | OK |
| | 4 | UNSTABLE | UNSTABLE | OK | OK |
| | 8 | UNSTABLE | UNSTABLE | OK | OK |
| 0° C. to 10° C. | 2 | UNSTABLE | UNSTABLE | OK | OK |
| Evaluation: RT | 4 | UNSTABLE | UNSTABLE | OK | OK |
| | 8 | UNSTABLE | UNSTABLE | OK | OK |

It is clear from the stability tests that establishing the ratio according to the invention of nonionic surfactants to anionic surfactants of at least 0.75:1 gives rise to low-concentration (the total surfactant content amounts 13.73 wt. % in Examples E5 and E6) washing or cleaning agents with elevated perfume oil contents which are stable in storage under the most varied climatic conditions.

Table 6 below shows the compositions of three formulations according to the invention, E7 to E9 (all quantities are stated in wt. % active substance, relative to the agent):

TABLE 6
Composition of washing or cleaning agents E7 to E9 (stated in wt. %)

| | E7 | E8 | E9 |
|---|---|---|---|
| C₁₂₋₁₈ fatty alcohol with 7 EO | 6.4 | 6.4 | 6.4 |
| Linear C₁₀-C₁₃ alkylbenzene | 5.35 | 5.35 | 5.35 |
| sulfonate (Na salt) | | | |
| C₁₂₋₁₈ fatty acid (sodium salt) | 1.98 | 1.98 | 1.98 |
| Citric acid (sodium salt) | 1.2 | 1.2 | 1.2 |
| Phosphonic acid | 0.5 | 0.5 | 0.5 |
| Boric acid (Na salt) | 1.06 | 1.06 | 1.06 |
| Polyacrylate thickener | 0.3 | 0.3 | 0.3 |
| Optical brightener | 0.08 | 0.08 | 0.08 |
| Glycerol | 3 | 3 | 3 |
| Ethanol | 1 | 1 | 1 |
| Silicone defoamer | 0.01 | 0.01 | 0.01 |
| Enzymes (protease & amylase) | 0.1 | 0.1 | 0.1 |
| Perfume C | 0.78 | 1.0 | 1.2 |
| Dye, preservative | + | + | + |
| Water | Ad 100 | Ad 100 | Ad 100 |
| Nonionic surfactant to anionic | 0.87:1 | 0.87:1 | 0.87:1 |
| surfactant ratio | | | |

All three of the compositions were without change (“OK”) over 8 weeks under the six above-stated different storage and determination conditions.

Perfume oils A to C used for the purposes of the present invention in each case contain at least 15 wt. % fragrances with a boiling point of above 250° C. and a logP value or ClogP value of ≧3.0. The content of these fragrances in the respective perfume oils A to C increases in the following sequence: perfume oil A<perfume oil B<perfume oil C.

In washing tests using washing or cleaning agents containing a surfactant mixture of nonionic and anionic surfactants, in which the ratio of nonionic surfactants to anionic surfactants amounts to at least 0.75:1, it was found that it is advantageous for the washing or cleaning agents to contain more than 3.2 wt. % of an alkylaryl sulfonate.

TABLE 7
Composition of the washing or cleaning agents
E10 to E12 (stated in wt. %)

| | E10 | E11 | E12 |
|---|---|---|---|
| C₁₂₋₁₈ fatty alcohol with 7 EO | 6.4 | 7.2 | 8.0 |
| Linear C₁₀-C₁₃ alkylbenzene | 5.35 | 4.28 | 3.20 |
| sulfonate (Na salt) | | | |
| C₁₂₋₁₈ fatty acid (sodium salt) | 1.98 | 1.98 | 1.98 |
| Citric acid (sodium salt) | 1.2 | 1.2 | 1.2 |
| Phosphonic acid | 0.5 | 0.5 | 0.5 |
| Boric acid (Na salt) | 1.06 | 1.06 | 1.06 |
| Polyacrylate thickener | 0.3 | 0.3 | 0.3 |
| Optical brightener | 0.08 | 0.08 | 0.08 |
| Glycerol | 3 | 3 | 3 |
| Ethanol | 1 | 1 | 1 |
| Silicone defoamer | 0.01 | 0.01 | 0.01 |
| Enzymes (protease & amylase) | 0.1 | 0.1 | 0.1 |
| Perfume C | 0.78 | 1.0 | 1.2 |
| Dye, preservative | + | + | + |
| Water | Ad 100 | Ad 100 | Ad 100 |
| Nonionic surfactant to anionic | 0.87:1 | 1.15:1 | 1.54:1 |
| surfactant ratio | | | |

All three of the compositions were without change (“OK”) over 8 weeks under the six above-stated different storage and determination conditions.

Washing or cleaning agent E12 did, however, exhibit poorer cleaning performance on greasy stains:

TABLE 8
Comparison of cleaning performance of the washing or
cleaning agent E12 with the washing or cleaning agents E10 and E11

| Stain | In comparison with E10 | In comparison with E11 |
|---|---|---|
| Lipstick | −4.1% | −5.4% |
| Make-up | −12.7% | −8.1% |
| Engine oil | −2.1% | −0.9% |

We claim:

1. Liquid washing or cleaning agent comprising:
a perfume oil, and
5 to 18 wt. % of a surfactant mixture of nonionic and anionic surfactants,
wherein the anionic surfactant is at least an alkylaryl sulfonate and wherein the quantity of alkylaryl sulfonate is 3.2 wt. % or greater,
wherein the ratio of nonionic surfactants to anionic surfactants is at least 0.75:1, and
wherein the ratio of nonionic surfactants to perfume oil is from 5:1 to 30:1.

2. Washing or cleaning agent according to claim 1, wherein the ratio of nonionic surfactants to perfume oil is from 5:1 to 15:1.

3. Washing or cleaning agent according to claim 1, wherein the amount of surfactant mixture is from 8 to 15 wt. %.

4. Washing or cleaning agent according to claim 1, wherein the ratio of nonionic surfactants to anionic surfactants is from 0.75:1 to 5:1.

5. Washing or cleaning agent according to claim 1, wherein the anionic surfactant is chosen from sulfonates, sulfates, soaps and mixtures thereof.

6. Washing or cleaning agent according to claim 1, wherein the quantity of perfume oil amounts to 0.4 to 1.5 wt. %.

7. Washing or cleaning agent according to claim 1, wherein the perfume oil contains at least 15 wt. % of fragrances having a boiling point of above 250° C. and a logP value of 3.0.

8. Method of washing and/or cleaning textile fabrics comprising washing textile fabrics with the washing or cleaning agent according to claim 1.

9. Method for producing a liquid washing or cleaning agent containing a perfume oil and 5 to 18 wt. % of a surfactant mixture of nonionic and anionic surfactants, in which the anionic surfactant is an alkylaryl sulfonate and the quantity of alkylaryl sulfonate amounts to more than 3.2 wt. % and in which nonionic surfactants are added to the agent at least in a ratio of 0.75:1 relative to the anionic surfactants and in a ratio of between 5:1 and 30:1 relative to the perfume oil.

10. Method of improving storage stability of a liquid washing or cleaning agent containing a perfume oil on storage in a temperature range from 0° C. to 10° C. comprising preparing a surfactant mixture of nonionic and anionic surfactants wherein the ratio of nonionic surfactants to anionic surfactants is at least 0.75:1, wherein the surfactant mixture is present in an amount of up to 25 wt. % based on total agent, and wherein the ratio of nonionic surfactants to perfume oil is from 5:1 to 30:1.

11. Method of improving storage stability of a liquid washing or cleaning agent containing a perfume oil on storage in a temperature range from 10° C. to 30° C., comprising preparing a surfactant mixture of nonionic and anionic surfactants wherein the ratio of nonionic surfactants to anionic surfactants is at least 0.75:1, wherein the surfactant mixture is present in an amount of up to 25 wt. %, wherein the agent comprises 0.5 to 1.5 wt. % of a perfume oil, and wherein the ratio of nonionic surfactants to perfume oil is from 5:1 to 30:1.

12. Method of a surfactant mixture of nonionic and anionic surfactants containing a perfume oil on storage in a temperature range from 24° C. to 40° C., comprising preparing a surfactant mixture of nonionic and anionic surfactants wherein the ratio of nonionic surfactants to anionic surfactants is at least 0.75:1, wherein the surfactant mixture is present in an amount of up to 25 wt. % based on total agent for improving the storage stability of a liquid washing or cleaning agent, wherein the agent comprises 0.5 to 1.5 wt. % of, and wherein the ratio of nonionic surfactants to perfume oil is from 5:1 to 30:1.
